(19) United States
(12) Patent Application Publication
(10) Pub. No.: US 2012/0044400 A1
(43) Pub. Date: Feb. 23, 2012

(54) IMAGE PICKUP APPARATUS

(75) Inventors: Seiji OKADA, Hirakata City (JP); Haruo HATANAKA, Kyoto City (JP); Kazuhiro KOJIMA, Higashiosaka City (JP); Yoshiyuki TSUDA, Hirakata City (JP)

(73) Assignee: SANYO Electric Co., Ltd., Moriguchi City (JP)

(21) Appl. No.: 13/207,006

(22) Filed: Aug. 10, 2011

(30) Foreign Application Priority Data
Aug. 20, 2010 (JP) 2010-185655

(51) Int. Cl. H04N 5/232

(52) U.S. Cl. 348/333.01; 348/345; 348/E05.045

(57) ABSTRACT

An image pickup apparatus includes an operating portion that receives an operation to instruct to obtain a target input image based on an output signal of an image pickup portion, an aimed image generating portion that generates an aimed image in which a specific subject is focused by performing a first image processing on the target input image after the target input image is recorded, and a blurred image generating portion that generates a blurred image in which a non-specific subject is blurred by performing a second image processing on the output signal of the image pickup portion before the operation to instruct to obtain is performed. Before the target input image is obtained in accordance with the operation to instruct to obtain, the blurred image is displayed on the display portion.

### CROSS-REFERENCE TO RELATED APPLICATIONS

This nonprovisional application claims priority under 35 U.S.C. §119(a) on Patent Application No. 2010-185655 filed in Japan on Aug. 20, 2010, the entire contents of which are hereby incorporated by reference.

### BACKGROUND OF THE INVENTION

1. Field of the Invention

The present invention relates to an image pickup apparatus such as a digital still camera or a digital video camera.

2. Description of Related Art

There is proposed a function of adjusting a focused state of a taken image by image processing, and one type of process for realizing this function is also called “digital focus”. As application methods of the digital focus, there are first and second application methods as follows.

In the first application method, after an original image is taken in accordance with a shutter operation, an aimed image in which a specific subject is focused is promptly generated from the original image by the digital focus without waiting user's instruction. Then, only the aimed image is recorded in the recording medium.

In the second application method, the original image is temporarily recorded in the recording medium without performing the digital focus on the original image taken in accordance with the shutter operation. Later, when the user instructs to generate the aimed image in a reproducing mode or the like, the original image is read out from the recording medium and is processed by the digital focus so that the aimed image is generated. For instance, there is proposed a method in which the original image is recorded in the recording medium, and later the user selects and specifies a subject to be focused by using a touch panel or the like, so that the digital focus is performed in accordance with the specified contents.

Note that there is also proposed a method in which a deblurring process (blur restoration process) is performed only when capturing, while the deblurring process is not performed when obtaining a through image.

In the image pickup apparatus that adopts the first application method, if the aimed image can be generated and displayed in real time whenever the original image is obtained, the user can check the aimed image to be recorded on the display screen each time. However, it takes substantial time to perform an operational process necessary for obtaining the aimed image. Therefore, it is difficult in many cases to generate and display the aimed image in real time as described above. Therefore, the user of the actual image pickup apparatus adopting the first application method can check only later in many cases about the focused state of the aimed image that is recorded. Then, only an image in which a subject that is not noted by the user is focused may be recorded as an image unwanted by the user, while the image in a focused state desired by the user may not be obtained.

If the second application method is adopted, such a situation can be avoided. However, when the second application method is adopted, if only the original image is displayed when taking an image, the user cannot recognize an image that can be produced later. It is undesirable and inconvenient that the user cannot check the aimed image to be finally obtained at all when the image is taken, despite that the display screen is disposed for checking the image to be obtained. Note that the method, in which the deblurring process is performed only when capturing while the deblurring process is not performed when obtaining a through image, is not a technique that contributes to solution of the above-mentioned problem.

On the other hand, there are various procedures by which the user wants to obtain the aimed image. Therefore, it is also considered to be important to provide a method for generating and recording the aimed image by a procedure in accordance with user's taste.

### SUMMARY OF THE INVENTION

An image pickup apparatus according to an aspect of the present invention includes an image pickup portion that outputs an image signal of a subject group including a specific subject and a non-specific subject, an operating portion that receives an operation to instruct to obtain a target input image based on an output signal of the image pickup portion, a recording medium that records the target input image, an aimed image generating portion that generates an aimed image in which the specific subject is focused by performing a first image processing on the target input image when a predetermined operation is performed on the operating portion after the target input image is recorded, a display portion, and a blurred image generating portion that generates a blurred image in which the non-specific subject is blurred by performing a second image processing different from the first image processing on the output signal of the image pickup portion before the operation to instruct to obtain is performed. The blurred image is displayed on the display portion before the target input image is obtained in accordance with the operation to instruct to obtain.

An image pickup apparatus according to another aspect of the present invention includes an image pickup portion that outputs an image signal of a subject group including a specific subject, an operating portion that receives an operation to instruct to obtain a target input image based on an output signal of the image pickup portion, a recording medium, an aimed image generating portion that generates an aimed image in which the specific subject is focused by performing an image processing on the target input image, and a control portion that controls a recording action of the recording medium and an aimed image generating action of the aimed image generating portion in a mode selected from a plurality of modes. The plurality of modes includes a first mode in which the target input image is recorded in the recording medium, and later the aimed image generating portion generates the aimed image from the target input image when a predetermined operation is performed on the operating portion, and a second mode in which the aimed image generating portion generates the aimed image from the target input image and records the aimed image in the recording medium without waiting the predetermined operation performed on the operating portion.

### BRIEF DESCRIPTION OF THE DRAWINGS

FIG. 1 is a schematic general block diagram of an image pickup apparatus according to a first embodiment of the present invention.

FIG. 2A is an internal block diagram of the image pickup portion illustrated in FIG. 1, and FIG. 2B is an internal structural diagram of one image pickup unit.

FIG. 3A is a diagram illustrating a relationship between a point light source and one image pickup unit, and FIG. 3B is a diagram illustrating an image of the point light source on a two-dimensional image.

FIGS. 4A and 4B are diagrams illustrating a manner in which a subject group is positioned within a depth of field of each image pickup unit.

FIG. 5 is a diagram illustrating an example of the subject group according to the first embodiment of the present invention together with subject distances.

FIG. 6 is an internal block diagram of an image processing portion illustrated in FIG. 1.

FIG. 7 is a diagram illustrating an outline of a process in which an aimed image is generated from first and second original images.

FIG. 8 is an action flowchart of the image pickup apparatus in a special imaging mode according to the first embodiment of the present invention.

FIG. 9 is an action flowchart of the image pickup apparatus in a reproducing mode according to the first embodiment of the present invention.

FIG. 10 is a diagram illustrating an example of a reference original image taken in the special imaging mode according to the first embodiment of the present invention.

FIG. 11 is a diagram illustrating a manner in which a main subject area is set in the reference original image of FIG. 10.

FIG. 12 is a diagram illustrating a manner in which a plurality of candidates of a main subject are displayed.

FIG. 13 is a diagram illustrating an example of a simple blurred image based on the reference original image of FIG. 10.

FIG. 14 is a diagram illustrating a manner in which a reference original image and a simple blurred image are switched and displayed in a time sharing manner during a check display period according to the first embodiment of the present invention.

FIG. 15 is a diagram illustrating another example of the simple blurred image based on the reference original image of FIG. 10.

FIG. 16 is a diagram illustrating a distance range of an aimed depth of field in digital focus.

FIGS. 17A and 17B are diagrams illustrating manners in which a reference original image sequence and a simple blurred image sequence are displayed, respectively, as a moving image in the check display period.

FIG. 18 is a diagram illustrating a manner in which two display areas are set on the display screen.

FIG. 19 is a diagram illustrating a manner in which the reference original image and the simple blurred image are displayed simultaneously using the two display areas illustrated in FIG. 18.

FIG. 20 is a diagram illustrating an example of the subject group according to a second embodiment of the present invention together with subject distances.

FIG. 21A is a diagram illustrating an example of the reference original image taken in the special imaging mode according to the second embodiment of the present invention, and FIG. 21B is a diagram illustrating a manner in which three main subject areas are set in the reference original image.

FIGS. 22A to 22C are diagrams illustrating three simple blurred images based on the reference original image of FIG. 21A.

FIG. 23 is a diagram illustrating a manner in which the reference original image and the three simple blurred image are switched and displayed in a time sharing manner during the check display period according to the second embodiment of the present invention.

FIGS. 24A to 24C are diagrams illustrating a manner in which the reference original image and the simple blurred image are displayed simultaneously according to the second embodiment of the present invention.

FIG. 25 is a diagram illustrating a manner in which five display areas are set on the display screen according to the second embodiment of the present invention.

FIG. 26 is a diagram illustrating a manner in which the reference original image and a plurality of simple blurred images are displayed simultaneously using the five display areas illustrated in FIG. 25.

FIG. 27 is a diagram illustrating a manner in which the reference original image and a plurality of simple blurred images are displayed simultaneously using the five display areas illustrated in FIG. 25.

FIG. 28 is a diagram illustrating a manner in which the reference original image and a plurality of simple blurred images are displayed simultaneously using the five display areas illustrated in FIG. 25.

### DETAILED DESCRIPTION OF THE PREFERRED EMBODIMENTS

Hereinafter, examples of embodiments of the present invention are described below in detail with reference to the attached drawings. In the drawings to be referred to, the same part is denoted by the same numeral or symbol, and overlapping description of the same part is omitted as a rule.

### First Embodiment

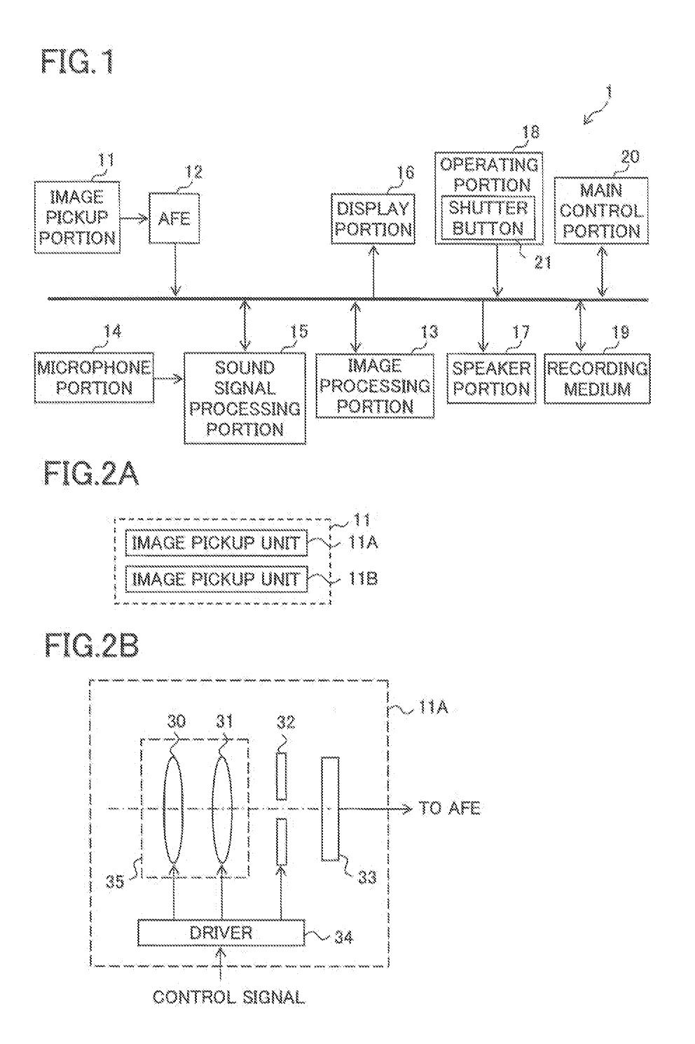

A first embodiment of the present invention is described. FIG. 1 is a schematic general block diagram of an image pickup apparatus 1 according to the first embodiment. The image pickup apparatus 1 is a digital still camera that can take and record still images or a digital video camera that can take and record still images and moving images. The image pickup apparatus 1 may be one incorporated in a mobile terminal such as a mobile phone.

The image pickup apparatus 1 is equipped with an image pickup portion 11, an AFE 12, an image processing portion 13, a microphone portion 14, a sound signal processing portion 15, a display portion 16, a speaker portion 17, an operating portion 18, a recording medium 19 and a main control portion 20. The operating portion 18 is provided with a shutter button 21.

As illustrated in FIG. 2A, image pickup units 11A and 11B are disposed in the image pickup portion 11. An internal structure of the image pickup unit 11A is the same as an internal structure of the image pickup unit 11B. Therefore, with reference to FIG. 2B, the internal structure of the image pickup unit 11A is described as a representative of the image pickup units 11A and 11B. FIG. 2B is an internal structural diagram of the image pickup unit 11A.

The image pickup unit 11A includes an optical system 35, an aperture stop 32, an image sensor 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 and a focus lens 31. The zoom lens 30 and the focus lens 31 can be moved in the optical axis direction. The driver 34 drives and controls positions of the zoom lens 30 and the focus lens 31 as well as an opening degree of the aperture stop 32, based on a control signal from the main control portion 20, so as to control a focal length (angle of view) and a focal position of imaging by the image pickup unit 11A, and incident light amount to the image sensor 33 (i.e., an aperture stop value).

The image sensor 33 performs photoelectric conversion of an optical image indicating the subject entering through the optical system 35 and the aperture stop 32, and outputs an image signal as an electrical signal obtained by the photoelectric conversion to the AFE 12. The AFE 12 amplifies an analog image signal output from the image sensor 33 and converts the amplified image signal into a digital image signal. The AFE 12 outputs the digital image signal as RAW data to the image processing portion 13. An amplification degree of the signal amplification in the AFE 12 is controlled by the main control portion 20. The RAW data based on the output signal of the image sensor 33 in the image pickup unit 11A is referred to as a first RAW data, the RAW data based on the output signal of the image sensor 33 in the image pickup unit 11B is referred to as a second RAW data.

The image processing portion 13 performs necessary image processing on the first and second RAW data or on an arbitrary image data supplied from the recording medium 19 or the like, so as to generate desired image data. The image data handled by the image processing portion 13 contains, for example, a luminance signal and a color difference signal. Note that the RAW data is also one type of image data, and image signals output from the image sensor 33 and the AFE 12 are also one type of image data.

The microphone portion 14 converts ambient sounds of the image pickup apparatus 1 into a sound signal and outputs the result. The sound signal processing portion 15 performs necessary sound signal processing on the output sound signal of the microphone portion 14.

The display portion 16 is a display device including a display screen of a liquid crystal display panel or the like, which displays a taken image or an image recorded in the recording medium 19 under control of the main control portion 20. It is possible to consider that a display control portion (not shown) that controls display content of the display portion 16 is included in the main control portion 20. A display and a display screen in the following description indicate a display and a display screen of the display portion 16 unless otherwise noted. It is also possible to dispose a touch panel on the display portion 16. An operation on the touch panel is referred to as a touch panel operation. The speaker portion 17 is constituted of one or more speakers, which reproduce any sound signal such the sound signal generated by the sound signal processing portion 15 or the sound signal read out from the recording medium 19, as sounds. The operating portion 18 is a portion that receives various operations performed by the user. The user means a user of the image pickup apparatus 1 including a photographer. An operation on the operating portion 18 is referred to as a button operation. The button operation includes an operation on a button, a lever, a dial or the like that can be provided to the operating portion 18. Contents of the button operation and the touch panel operation are sent to the main control portion 20 and the like. The recording medium 19 is a nonvolatile memory such as a card-like semiconductor memory or a magnetic disk, which stores image data and the like under control of the main control portion 20. The main control portion 20 integrally controls actions of individual portions of the image pickup apparatus 1 in accordance with the contents of the button operation and the touch panel operation.

Operation modes of the image pickup apparatus 1 include an imaging mode in which a still image or a moving image can be taken, and a reproducing mode in which a still image or a moving image recorded in the recording medium 19 can be reproduced on the display portion 16. In the imaging mode, the image pickup units 11A and 11B periodically take images of subjects at a predetermined frame period, and the image pickup unit 11A (more specifically AFE 12) outputs first RAW data indicating a taken image sequence of the subjects while the image pickup unit 11B (more specifically AFE 12) outputs second RAW data indicating a taken image sequence of the subjects. An image sequence such as a taken image sequence means a set of images arranged in time series. Image data of one frame period expresses one image. One taken image expressed by image data of one frame period is referred to also as a frame image.

In addition, the frame image expressed by the first RAW data of one frame period is referred to as a first original image. The first original image may be an image obtained by performing a predetermined image processing (a demosaicing process, a noise reduction process, a color correction process or the like) on the first RAW data of one frame period. Similarly, the frame image expressed by the second RAW data of one frame period is referred to as a second original image. The second original image may be an image obtained by performing a predetermined image processing (a demosaicing process, a noise reduction process, a color correction process or the like) on the second RAW data of one frame period. The first original image and the second original image may be referred to as an original image individually or collectively. Note that in this specification image data of an arbitrary image may be simply referred to as an image. Therefore, for example, an expression “to record the first original image” has the same meaning as an expression “to record image data of the first original image”.

In each of the image pickup units 11A and 11B, it is possible to obtain the original images having various depths of field by controlling the optical system 35 and the aperture stop 32. However, in a special imaging mode as one type of the imaging mode, the original image having a substantially large depth of field is obtained by the image pickup units 11A and 11B. The original image in the following description means an original image obtained in the special imaging mode.

The original image obtained in the special imaging mode functions as a pan-focus image. The pan-focus image means an image in which subjects having image data on the pan-focus image are all focused.

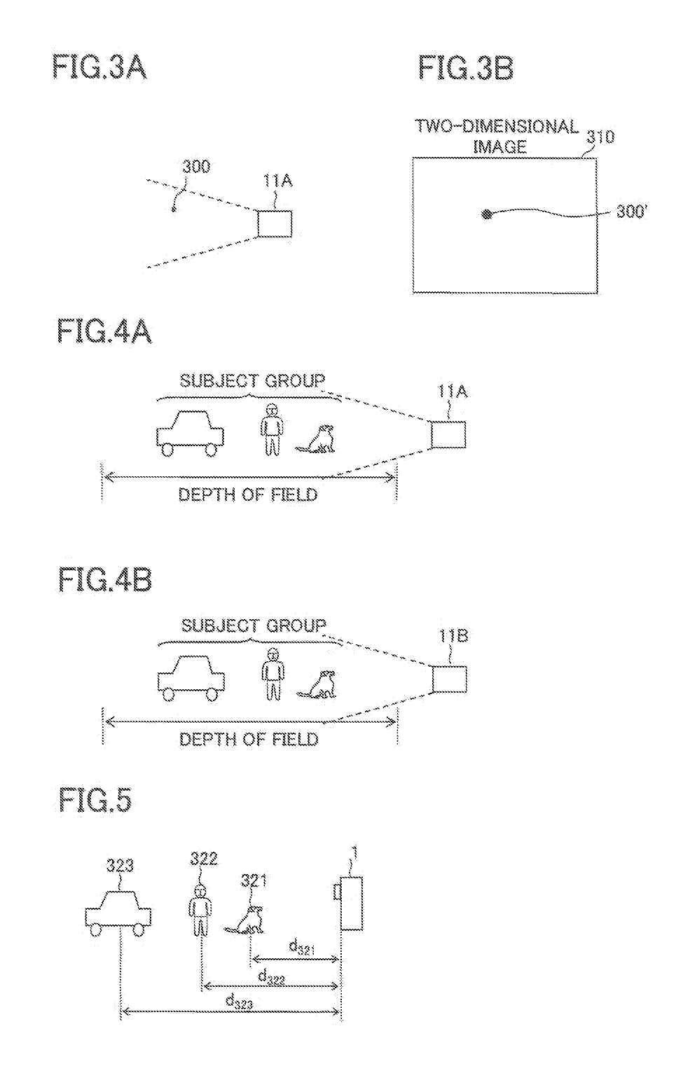

Noting the image pickup unit 11A, meaning of “focus” is described. As illustrated in FIG. 3A, it is supposed that an ideal point light source 300 is included as a subject in an imaging range of the image pickup unit 11A. In the image pickup unit 11A, incident light from the point light source 300 forms an image via the optical system 35 on an imaging point. If the imaging point is on an imaging surface of the image sensor 33, a diameter of the image of the point light source 300 on the imaging surface is sufficiently smaller than a predetermined reference diameter. On the other hand, if the imaging point is not on the imaging surface of the image sensor 33, the optical image of the point light source 300 on the imaging surface is blurred. As a result, the diameter of the image of the point light source 300 on the imaging surface can be larger than the reference diameter. If the diameter of the image of the point light source 300 on the imaging surface is smaller than or equal to the reference diameter, the subject as the point light source 300 is focused on the imaging surface. If the diameter of the image of the point light source 300 on the imaging surface is larger than the reference diameter, the subject as the point light source 300 is not focused on the imaging surface. The reference diameter is, for example, a diameter of a permissible circle of confusion of the image sensor 33.

Similarly, as illustrated in FIG. 3B, in the case where an image 300′ of the point light source 300 is included as a subject image in a two-dimensional image 310, if a diameter of the image 300′ in the two-dimensional image 310 is smaller than or equal to a predetermined threshold value corresponding to the above-mentioned reference diameter, the subject as the point light source 300 is focused on the two-dimensional image 310. If the diameter of the image 300′ in the two-dimensional image 310 is larger than the predetermined threshold value, the subject as the point light source 300 is not focused on the two-dimensional image 310. In the two-dimensional image 310, a subject that is focused is referred to as an in-focus subject, and a subject that is not focused is referred to as a non-focus subject. The two-dimensional image 310 is an arbitrary two-dimensional image. Images in this specification are all two-dimensional images unless otherwise noted. If a certain subject is positioned within the depth of field of the two-dimensional image 310 (i.e., if a subject distance of the subject is within the depth of field of the two-dimensional image 310), the subject is an in-focus subject on the two-dimensional image 310. If a certain subject is not positioned within the depth of field of the two-dimensional image 310 (i.e., if a subject distance of the subject is not within the depth of field of the two-dimensional image 310), the subject is a non-focus subject on the two-dimensional image 310.

The original image obtained in the special imaging mode is an ideal pan-focus image or a pseudo-pan-focus image. More specifically, for example, so-called pan focus (deep focus) is used in the image pickup unit 11A so that the first original image can be an ideal pan-focus image or a pseudo-pan-focus image (the same is true for the image pickup unit 11B and the second original image). In other words, the depth of field of the image pickup unit 11A should be set to be sufficiently deep for taking the first original image. As illustrated in FIG. 4A, if all subjects included in the imaging range of the image pickup unit 11A are within the depth of field of the image pickup unit 11A when the first original image is taken, the first original image functions as an ideal pan-focus image. Similarly, as illustrated in FIG. 4B, if all subjects included in the imaging range of the image pickup unit 11B are within the depth of field of the image pickup unit 11B when the second original image is taken, the second original image functions as an ideal pan-focus image. In the following description of the first embodiment, it is supposed that all subjects included in the imaging range of the image pickup unit 11A are within the depth of field of the image pickup unit 11A when the first original image is taken, and that all subjects included in the imaging range of the image pickup unit 11B are within the depth of field of the image pickup unit 11B when the second original image is taken (the same is true in the second embodiment described later).

There is a common imaging range between the imaging range of the image pickup unit 11A and the imaging range of the image pickup unit 11B. A part of the imaging range of the image pickup unit 11A and a part of the imaging range of the image pickup unit 11B may form a common imaging range. However, in the following description, for simple description, it is supposed that imaging ranges of the image pickup units 11A and 11B are completely the same. Therefore, subjects imaged by the image pickup unit 11A and subjects imaged by the image pickup unit 11B are completely the same.

However, there is parallax between the image pickup units 11A and 11B. In other words, the visual point of the first original image and the visual point of the second original image are different to each other. It can be considered that a position of the image sensor 33 in the image pickup unit 11A corresponds to the visual point of the first original image, and that a position of the image sensor 33 in the image pickup unit 11B corresponds to the visual point of the second original image.

FIG. 5 indicates a subject group positioned in the imaging ranges of the image pickup units 11A and 11B. This subject group includes a dog as a subject 321, a person as a subject 322 and a car as a subject 323. The subject distances of the subjects 321 to 323 are denoted by d₃₂₁, d₃₂₂, and d₃₂₃, respectively. Here, it is supposed that “0<d₃₂₁, <d₃₂₂, <d₃₂₃” holds, and that the subject distances d₃₂₁, d₃₂₂ and d₃₂₃ are not changed for simple description. The subject distance of the subject 321 means a distance between the subject 321 and the image pickup apparatus 1 in the real space. The same is true for subject distances of subjects other than the subject 321.

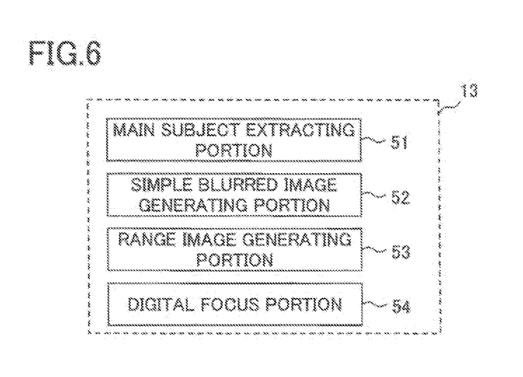

As illustrated in FIG. 6, the image processing portion 13 includes a main subject extracting portion 51, a simple blurred image generating portion 52, a range image generating portion 53 and a digital focus portion 54, which work effectively when the special imaging mode is used.

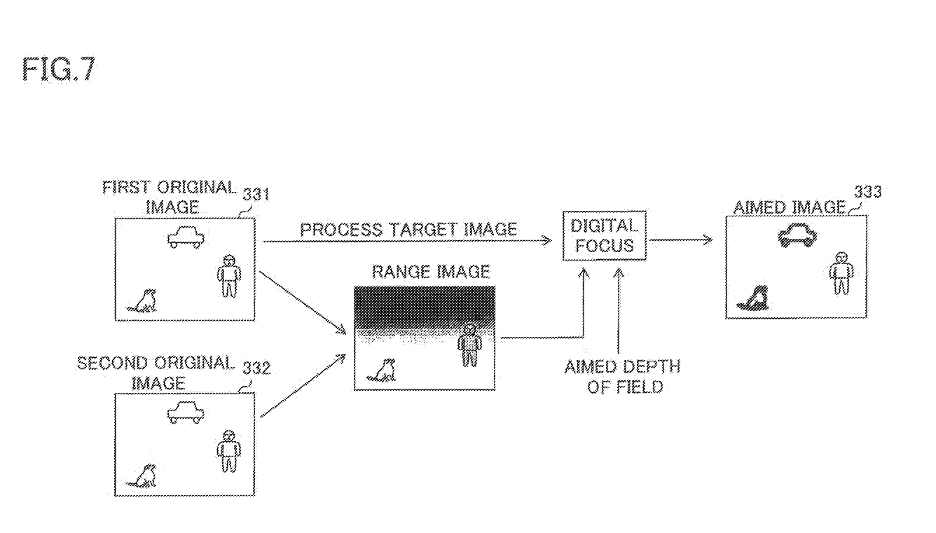

FIG. 7 is a diagram illustrating a manner in which an aimed image (in other words, a destination image) is generated from the first and second original images obtained in the special imaging mode. The range image generating portion 53 can generate a range image from the first and second original images using the triangulation principle based on a parallax between the image pickup units 11A and 11B when the first and second original images are taken. The generated range image is a range image with respect to imaging ranges of the image pickup units 11A and 11B. The range image is an image (a distance image) in which each pixel value of the image has a measured value (i.e., a detected value) of the subject distance. The range image enables to specify a subject distance of a subject at an arbitrary pixel position in the first original image, as well as a subject distance of a subject at an arbitrary pixel position in the second original image.

The digital focus portion 54 of FIG. 6 can realize image processing of adjusting a focused state of a process target image. This image processing is referred to as digital focus. A process target image of the digital focus portion 54 is the first or second original image. The digital focus enables to generate the aimed image having an arbitrary in-focus distance and an arbitrary depth of field from the process target image. The in-focus distance means a reference distance belonging to the depth of field, and indicates a distance in the center of the depth of field, for example. When the digital focus is performed, an aimed depth of field is referred to. The aimed depth of field expresses a depth of field of the aimed image, and is set so that a specific subject (a focus aimed subject described later) is focused in the aimed image. Therefore, the digital focus portion 54 performs the digital focus using the range image on the process target image so that each subject having a subject distance within the aimed depth of field becomes an in-focus subject in the aimed image and that each subject having a subject distance beyond the aimed depth of field becomes a non-focus subject in the aimed image, and thus the aimed image is generated. In this case, as a subject distance of a certain non-focus subject becomes farther from the aimed depth of field, this non-focus subject image is blurred more in the aimed image. In other words, for example, if the non-focus subject is the point light source 300, the diameter of the image 300′ of the point light source 300 in the aimed image increases as the subject distance of the point light source 300 becomes farther from the aimed depth of field.

In the example illustrated in FIG. 7, it is supposed that a first original image 331 and a second original image 332 are obtained by imaging the subjects 321 to 323 using the image pickup units 11A and 11B, and that only the subject distance d₃₂₂ among the subject distances d₃₂₁ to d₃₂₃ is within the aimed depth of field. Therefore, in an aimed image 333 in the example of FIG. 7, only the subject 322 is an in-focus subject, and the subjects 321 and 323 are non-focus subjects. In other words, in the aimed image 333, only the subject 322 is shown clearly, while images of the subjects 321 and 323 are blurred. Note that in the diagrams illustrating the aimed image or a simple blurred image described later, bokeh (blur) of the image is expressed by thickening the contour of the subject.

Here, there is considered an example of procedure for obtaining the aimed image by the above-mentioned method, in which after the original image is taken by the shutter operation, the aimed image in which a specific subject is focused is generated from the original image by the digital focus promptly without waiting a user's instruction, and only the aimed image is recorded in the recording medium. If the aimed image can be generated and displayed in real time whenever a set of first and second original images is obtained, the user can check the aimed image to be recorded on the display screen each time. However, the processes necessary for obtaining the aimed image (the process of deriving the range image from the first and second original images and the process of changing the focused state of the process target image using the range image) take substantial time. Therefore, it is difficult in many cases to generate and display the aimed image in real time as described above. Therefore, the user of the actual system adopting the above-mentioned procedure example can check only later in many cases about the focused state of the recorded aimed image. Then, only an image in which a subject that is not noted by the user is focused may be recorded as an image unwanted by the user, while the image in a focused state desired by the user may not be obtained. This situation should be avoided as a matter of course.

Therefore, the image pickup apparatus 1 adopts an example of procedure in which image data of the original image is recorded in the recording medium 19 in the special imaging mode, and later the aimed image is generated from the recorded data in the reproducing mode. However, in this case, if only the original image is displayed in the special imaging mode, the user cannot recognize what image can be generated later. If the aimed image to be obtained finally cannot be checked at all when the image is taken despite that there is a display screen for checking an image to be obtained, it is not convenient. Considering these circumstances, the image pickup apparatus 1 generates and displays the simple blurred image that is similar to the aimed image by image processing having a relatively small operating load, before recording the data to be a basis of generating the aimed image.

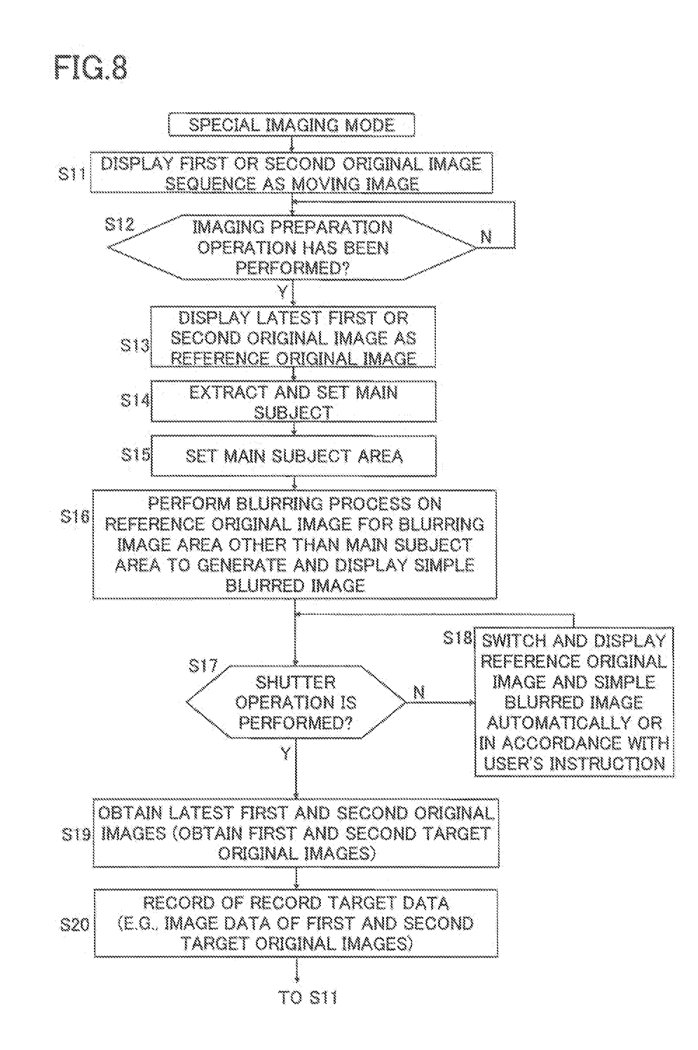

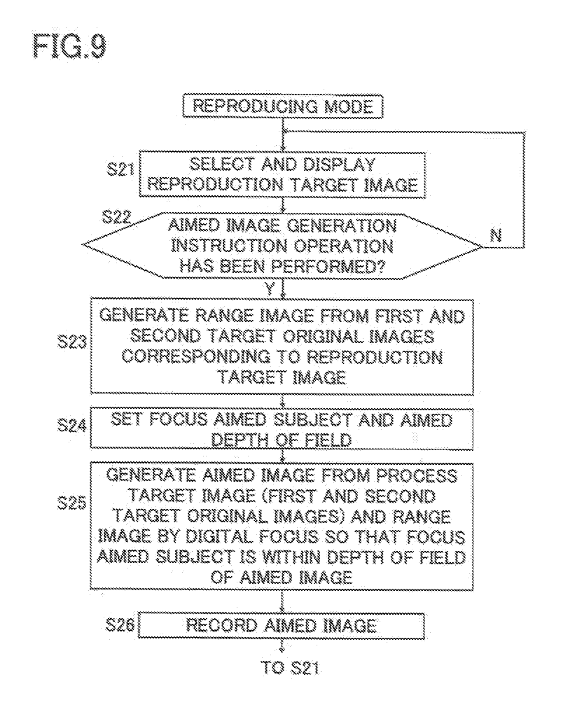

An example of realizing this method is described in detail with reference to FIGS. 8 and 9. FIG. 8 is a flowchart illustrating an action procedure of the image pickup apparatus 1 in the special imaging mode. in which the process of Steps S11 to S20 can be performed in the special imaging mode. FIG. 9 is a flowchart illustrating an action procedure of the image pickup apparatus 1 in the reproducing mode, in which the process of Steps S21 to S26 can be performed in the reproducing mode.

In the special imaging mode, a first original image sequence can be obtained by taking the first original image periodically with the image pickup unit 11A, and a second original image sequence can be obtained by taking the second original image periodically with the image pickup unit 11B. In Step S11, the first original image sequence or the second original image sequence is displayed as a moving image on the display portion 16. This display is performed continuously until Step S13. Note that when an arbitrary two-dimensional image is displayed on the display portion 16, resolution conversion of the two-dimensional image is performed if necessary.

In Step S12, the main control portion 20 decides whether or not imaging preparation operation has been performed on the image pickup apparatus 1. The decision process of Step S12 is performed repeatedly until the imaging preparation operation is performed. When the imaging preparation operation is performed, the process flow goes from Step S12 to Step S13, and the process of Step S13 is performed. The imaging preparation operation is, for example, a predetermined button operation (such as half pressing of the shutter button 21) or a touch panel operation.

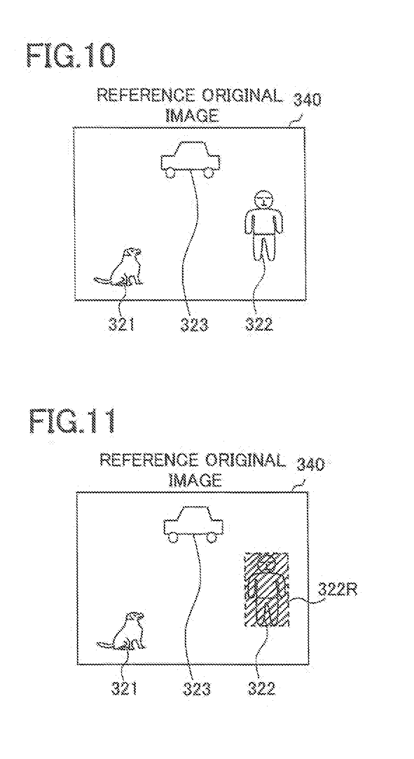

In Step S13, the image processing portion 13 sets the latest first or second original image obtained at that time point as the reference original image, and sends image data of the reference original image to the display portion 16, so that the reference original image is displayed on the display portion 16. The reference original image is, for example, a first or second original image taken just before the imaging preparation operation is performed, or a first or second original image taken just after the imaging preparation operation is performed. An image 340 of FIG. 10 is an example of the reference original image.

In Step S14 after Step S13, the main subject extracting portion (main subject setting portion) 51 of FIG. 6 extracts a main subject among the subject group existing in the reference original image. In other words, any subject among all subjects existing in the reference original image is selected and set as the main subject. Then, in the next Step S15, a main subject area that is an image area where image data of the main subject exists is set in the reference original image. Setting of the main subject area is performed by the main subject extracting portion 51 or the simple blurred image generating portion 52. The main subject area corresponds to a part of the entire image area of the reference original image. If the subject 322 on the reference original image 340 is set as the main subject, image area 322R surrounding the subject 322 on the reference original image 340 as illustrated in FIG. 11 (corresponding to the hatched area of FIG. 11) is set as the main subject area. Although the main subject area of FIG. 11 is a rectangular area, the outer shape of the main subject area is not limited to a rectangle.

Based on the image data of the reference original image, the main subject and the main subject area can be extracted and set.

Specifically, for example, a person in the reference original image can be detected using a face detection process based on the image data of the reference original image, and the detected person can be extracted as the main subject. The face detection process is a process of detecting an image area in which image data of the person's face exists as a face area. The face detection process can be realized using any known method. After the face area is detected, an image area in which image data of the person's whole body exists can be detected as a person area by using a contour extraction process or the like. However, for example, if only the upper half body of the person exists in the reference original image, an image area in which image data of the person's upper half body exists can be detected as the person area. A position and a size of the person area in the reference original image may be estimated from a position and a size of the face area in the reference original image, so as to determine the person area. Then, if a specific person is set as the main subject, the person area of the specific person or the image area including the person area can be set as the main subject area. In this case, it is possible to set a center position or a barycenter position of the main subject area to be agreed with a center position or a barycenter position of the person area of the specific person.

Alternatively, for example, it is possible to detect a moving object in the reference original image using a moving object detection process based on image data of the reference original image, and to extract the detected moving object as the main subject. The moving object detection process is a process of detecting an image area in which image data of a moving object exists as a moving object area. The moving object means an object that is moving on the first or the second original image sequence. The moving object detection process can be realized using any known method. If a specific moving object is set as the main subject, the moving object area of the specific moving object or an image area including the moving object area can be set as the main subject area. In this case, it is possible to set the center position or the barycenter position in the main subject area to be agreed with the center position or the barycenter position in the moving object area of the specific moving object.

Still alternatively, for example, the main subject may be determined from information of composition or the like of the reference original image. In other words, for example, the main subject may be determined based on known information that the main subject is positioned in a middle part of the entire image area of the reference original image with high probability. In this case, for example, it is possible to divided the entire image area of the reference original image in each of the horizontal and vertical directions into a plurality of areas, and to set the center image area among the obtained plurality of image areas as the main subject area.

It is also possible to extract and set the main subject and the main subject area in accordance with a user's instruction.

In other words, for example, the user may designate a specific position on the reference original image displayed on the display portion 16 by the touch panel operation, and a subject existing in the specific position may be determined as the main subject. For instance, if the user designates the subject 322 on the reference original image 340 in the state where the reference original image 340 of FIG. 10 is displayed on the display screen, the subject 322 is set as the main subject. In this case, similarly to the method described above, the person area of the subject 322 is detected, and the main subject area is set with respect to the detected person area. In addition, it is possible that the user designates the position and size of the main subject area by the touch panel operation or the like.

It is also possible to extract and set the main subject and the main subject area by combination of the image data of the reference original image and the user's instruction.

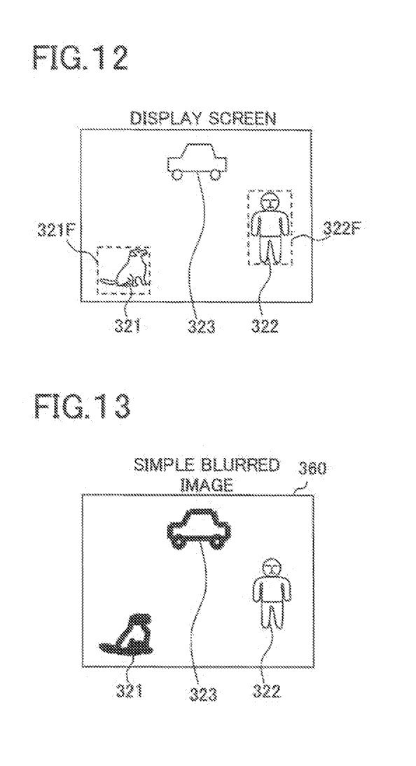

For instance, a plurality of subjects to be the main subject is extracted first in accordance with the above-mentioned method based on the image data of the reference original image, and each of the plurality of extracted subjects is set as a candidate of the main subject. Then, each of the candidates of the main subject is clearly expressed on the display screen. The user selects the main subject among the plurality of candidates by the touch panel operation or a predetermined operation on the operating portion 18 (cursor operation or the like). For instance, if the subjects 321 and 322 are set as candidates of the main subject in the state where the reference original image 340 of FIG. 10 is displayed on the display screen, a frame 321F enclosing the subject 321 and a frame 322F enclosing the subject 322 are superimposed and displayed on the reference original image 340 as illustrated in FIG. 12, and the user designates one of the frames 321F and 322F by the touch panel operation or the like. If the frame 321F is designated, the subject 321 is set as the main subject. If the frame 322F is designated, the subject 322 is set as the main subject. After that, the main subject area is set in accordance with set content of the main subject. As a setting method of the main subject area, any setting method described above can be used.

FIG. 8 is referred to again. When the main subject and the main subject area are set, the process of Step S16 is performed. In Step S16, the simple blurred image generating portion 52 of FIG. 6 splits the entire image area of the reference original image into the main subject area and a blurring target area that is an image area other than the main subject area. Then, image processing including a blurring process is performed, in which image within the blurring, target area is blurred. This image processing may include a contour enhancement process in which the contour of the image in the main subject area is enhanced. The reference original image after the above-mentioned blurring process is performed or the reference original image after the above-mentioned blurring process and contour enhancement process are performed is referred to as a simple blurred image. The generated simple blurred image is displayed on the display portion 16 in Step S16.

The blurring process may be a low pass filter process of reducing frequency components having relatively high spatial frequency among spatial frequency components of the image within the blurring target area. The blurring process may be realized by spatial domain filtering or frequency domain filtering. It is possible to simply switch execution or non-execution of the blurring process in the boundary between the main subject area and the blurring target area. However, in order to smooth the image in the boundary between the main subject area and the blurring target area, it is possible to calculate weighted average of image data after the blurring process and image data before the blurring process in the vicinity of the boundary between the main subject area and the blurring target area, and to use the image data obtained by the weighted average as image data in the vicinity of the boundary in the simple blurred image.

An image 360 illustrated in FIG. 13 is an example of the simple blurred image based on the reference original image 340 illustrated in FIG. 10. The simple blurred image 360 is generated when the image area 322R of FIG. 11 is set as the main subject area. In the simple blurred image 360, the subject 322 is not blurred while the subjects 321 and 323 are blurred among the subjects 321 to 323.

In Step S17 after Step S16, the main control portion 20 decides whether or not the shutter operation (operation to instruct to obtain a target input image) is performed on the image pickup apparatus 1. The decision process of Step S17 is performed repeatedly via the process of Step S18 until the shutter operation is performed. When the shutter operation is performed, the process flow goes from Step S17 to Step S19 so that the process of Step S19 and subsequent steps is performed. The shutter operation is, for example, a predetermined button operation (e.g., full pressing of the shutter button 21) or touch panel operation. Note that as clear from the above description, the image processing of Step S16 including the blurring process is performed on the image signal output from the image pickup portion 11 (specifically, the image signal output from the image pickup unit 11A or 11B) before the shutter instruction is issued (i.e., before the shutter operation is performed). As a matter of course, the image processing of Step S16 (second image processing) is different from the digital focus (first image processing) performed by the digital focus portion 54.

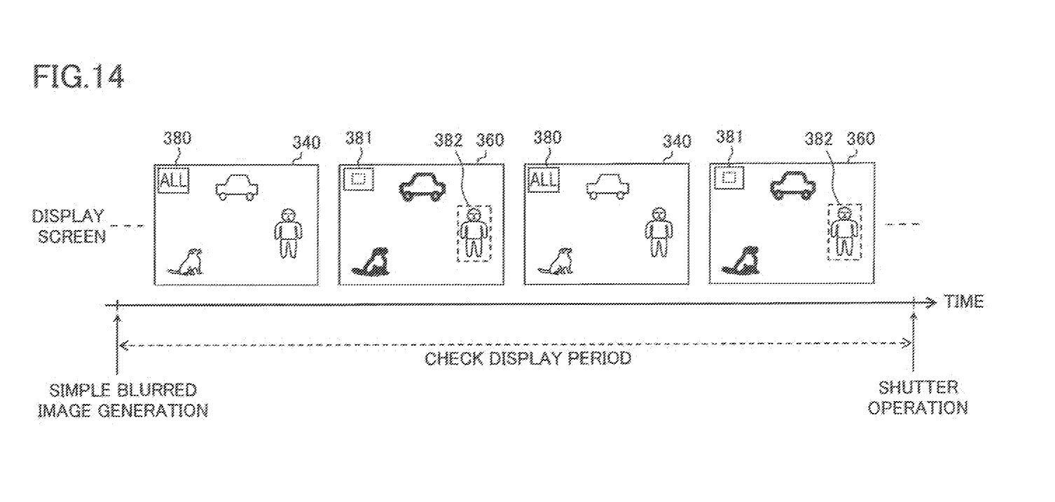

A period of time after the simple blurred image is generated in Step S16 until the shutter operation is performed is referred to as a check display period. In the check display period, the reference original image and the simple blurred image are switched and displayed automatically or in accordance with a user's instruction (Step S18). In other words, for example, as illustrated in FIG. 14, the reference original image 340 is displayed for a certain period of time, and then the simple blurred image 360 is displayed for a certain period of time. This series of displaying process is automatically performed repeatedly in the check display period without based on a user's instruction. Alternatively, for example, it is possible to switch the image to be displayed in accordance with a user's instruction by a predetermined button operation or touch panel operation in the check display period between the reference original image 340 and the simple blurred image 360.

When the reference original image 340 is displayed, it is possible to further display an icon 380 indicating that the displayed image is the reference original image. Similarly, when the simple blurred image 360 is displayed, it is possible to further display an icon 381 indicating that the displayed image is the simple blurred image. The display of the icons 380 and 381 enables the user to easily recognize whether the display image is the reference original image or the simple blurred image. In addition, when the simple blurred image 360 is displayed, it is possible to display an index for notifying the user of the position and size of the main subject area (a broken line frame 382 illustrated in FIG. 14) to be overlaid on the simple blurred image 360. Further, also when the reference original image 340 is displayed, it is possible to display the same index to be overlaid on the reference original image 340.

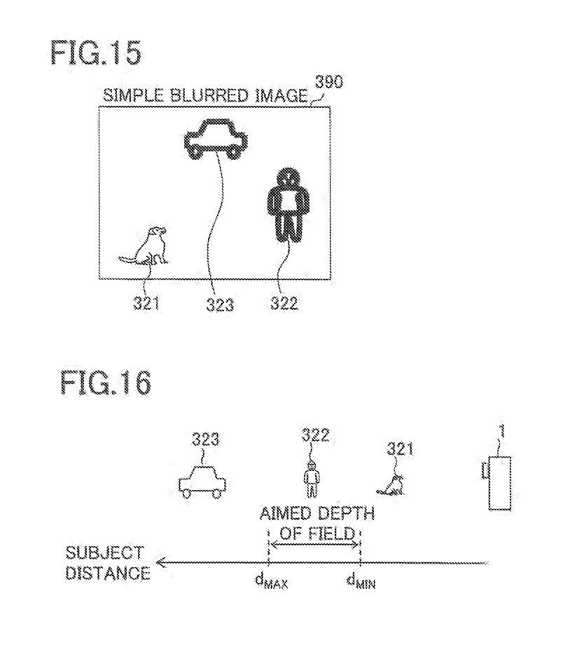

The user can instruct to change the main subject in the check display period. For instance, when the reference original image 340 and the simple blurred image 360 are switched and displayed in the check display period, the user can designate the subject 321 as the main subject by a predetermined button operation or touch panel operation. When this designation is performed, the main subject is changed from the subject 322 to the subject 321, and the process of Step S16 is performed again after the main subject area is reset in which the subject 321 is regarded as the main subject. An image 390 illustrated in FIG. 15 is an example of the simple blurred image obtained by performing the process of Step S16 again. When the simple blurred image 390 is generated, the reference original image 340 and the simple blurred image 390 are switched and displayed until the shutter operation is performed. When the shutter operation is performed, the process of Step S19 is performed. Note that the main subject can be changed any number of times in the check display period.

In Step S19, the latest first and second original images are obtained. The first original image and the second original image obtained in Step S19 are referred to as a first target original image and a second target original image, respectively. The first target original image and the second target original image are respectively first and second original images taken just before the shutter operation is performed or first and second original images taken just after the shutter operation is performed.

In Step S20 after Step S19, the main control portion 20 controls the recording medium 19 to record the record target data. For instance, it is supposed that the record target data contains image data of the first and second target original images, and that the first and second target original images are recorded in Step S20. After the record target data is recorded, the process flow goes back to Step S11, and the process of Step S11 and steps after Step S11 is performed repeatedly. If a predetermined button operation or touch panel operation for changing the operation mode to the reproducing mode is performed, the operation mode is switched from the special imaging mode to the reproducing mode, and then the process of Step S21 illustrated in FIG. 9 is performed. In the reproducing mode, the record target data recorded in the recording medium 19 can be sent to the image processing portion 13.

In Step S21, selection and display of the reproduction target image is performed. The reproduction target image means an image to be displayed on the display portion 16 in the reproducing mode. The user can select the reproduction target image from images recorded in the recording medium 19 by a predetermined button operation or touch panel operation, and the selected reproduction target image is displayed on the display portion 16 in Step S21. Any first target original image recorded in the recording medium 19 or any second target original image recorded in the recording medium 19 can be the reproduction target image. In Step S22 after Step S21, the main control portion 20 decides whether or not an aimed image generation instruction operation has been performed on the image pickup apparatus 1. The process of Steps S21 and S22 is repeatedly performed until the aimed image generation instruction operation is performed. When the aimed image generation instruction operation is performed, the process flow goes from Step S22 to Step S23, and the processes of Step S23 and Steps S24 to S26 are performed. The aimed image generation instruction operation is, for example, a predetermined button operation or touch panel operation.

In Step S23, the first and second target original images corresponding to the reproduction target image at the time point when the aimed image generation instruction operation is performed is read out from the recording medium 19. For instance, if the reproduction target image at the time point when the aimed image generation instruction operation is performed is the first original image 331 (see FIG. 7), the second original image 332 taken at the same time as the first original image 331 is read out from the recording medium 19 together with the first original image 331. Further, in Step S23, the range image generating portion 53 of FIG. 6 generates the above-mentioned range image from the first and second target original images read out from the recording medium 19. In other words, based on a parallax between the image pickup units 11A and 11B when the first and second target original images are taken, the range image is generated from the first and second target original images using the triangulation principle.

Next in Step S24, the focus aimed subject is set, and the aimed depth of field is set. The focus aimed subject is a subject to be an in-focus subject after the digital focus (i.e., an in-focus subject on the aimed image). The aimed depth of field specifies the smallest value d_{MIN} and the largest value d_{MAX} of the subject distance belonging to the depth of field of the aimed image (see FIG. 16). In the example of FIG. 16, only the subject 322 is positioned within the aimed depth of field. The setting of the focus aimed subject and the aimed depth of field can be performed by the main control portion 20 or the image processing portion 13. It is possible that the digital focus portion 54 performs the setting.

For instance, the main subject that had been set just before the shutter operation was performed may be set as the focus aimed subject. In order to realize this, main subject specifying data that specifies the main subject set before the shutter operation was performed should be included in the record target data. The main subject specifying data specifies positions of the main subject to be set as the focus aimed subject on the first and second target original images.

Alternatively, for example, it is possible to set the focus aimed subject using the same method as the main subject setting method illustrated in Step S14. In other words, it is possible to set the focus aimed subject based on image data of a reference target original image, or a user's instruction, or a combination of the image data of the reference target original image and the user's instruction. In this case, the main subject and the target original image in the description of the main subject setting method are read as the focus aimed subject and the reference target original image, respectively. The reference target original image is the first or second target original image corresponding to the process target image in Step S25 described later. Typically, for example, it is possible that the reference target original image is displayed on the display portion 16, and in this state the user designates a specific position on the reference target original image by a touch panel operation, so that the subject existing at the specific position is set as the focus aimed subject.

The aimed depth of field is set based on the range image so that the subject distance of the focus aimed subject is within the aimed depth of field. In other words, for example, if the subject 322 is the focus aimed subject, the subject distance d₃₂₂ is within the aimed depth of field. If the subject 321 is the focus aimed subject, the subject distance d₃₂₁ is within the aimed depth of field.

A magnitude of the aimed depth of field (i.e., a difference between d_{MIN} and d_{MAX}) is set to be as small (shallow) as possible so that a subject other than the focus aimed subject becomes the non-focus subject in the aimed image. However, a subject having a subject distance close to the subject distance of the focus aimed subject can be an in-focus subject together with the focus aimed subject in the aimed image. At least a magnitude of the aimed depth of field is smaller (shallower) than a magnitude of the depth of field of each target original image (in other words, the depth of field of each target original image is deeper than the depth of field of the aimed image). The magnitude of the aimed depth of field may be a predetermined fixed value or may be designated by the user.

In addition, it is possible to determine the v magnitude of the aimed depth of field using a result of a scene decision process of the first or second original image obtained just before or just after the shutter operation (in this case, the result of the scene decision should be included in the record target data). The scene decision process of the first original image is performed by using extraction of image feature quantity from the first original image, detection of a subject in the first original image, analysis of hue of the first original image, estimation of light source state of the subject when the first original image is taken, and the like. Any known method (e.g., a method described in JP-A-2008-11289 or JP-A-2009-71666) can be used in the decision thereof. The same is true for the scene decision process of the second original image. Further, for example, if it is decided in the scene decision process that the imaging scene of the first and second target original images is a landscape scene, the aimed depth of field may be set to be relatively deep. If it is decided that the imaging scene is a portrait scene, the aimed depth of field may be set to be relatively shallow.

After the aimed depth of field is set, the process target image and the range image are given to the digital focus portion 54 in Step S25, so that the aimed image is generated. The process target image is the first or second target original image read out from the recording medium 19. The digital focus portion 54 generates the aimed image from the process target image and the range image by the digital focus so that the focus aimed subject is within the depth of field of the aimed image (i.e., the aimed depth of field), in other words, so that the subject distance of the focus aimed subject is within the depth of field of the aimed image. The image data of the generated aimed image is recorded in the recording medium 19 in Step S26. It is possible to display the aimed image on the display portion 16 after the aimed image is generated. After recording in the recording medium 19 in Step S26, the process flow goes back to Step S21.

In this way, the image pickup portion 11 outputs the image signal of the subject group including the specific subject and the non-specific subject (the subject group including the subjects 321 to 323). The specific subject is any of the subjects 321 to 323, and the non-specific subject is also any of the subjects 321 to 323. However, the specific subject and the non-specific subject are different from each other. The operating portion 18 receives the shutter operation to instruct to obtain the target input image. In this embodiment, for example, the target input image is constituted of the first and second target original images. Note that the touch panel of the display portion 16 works as the operating portion when the shutter operation is a predetermined touch panel operation. If the specific subject is set to the main subject and the focus aimed subject, the simple blurred image generating portion 52 generates the simple blurred image in which subjects other than the specific subject (i.e., the non-specific subjects) are blurred by using the blurring process. The digital focus portion 54 generates the aimed image in which the specific subject is focused from the target input image by using the digital focus.

In this embodiment, prior to obtaining the target input image, the simple blurred image is generated and displayed. In other words, the simple blurred image that is supposed to be similar to the aimed image is generated from the output signal of the image pickup portion 11 before the shutter instruction performed, and the simple blurred image is provided to the user. Viewing the simple blurred image, the user can confirm an outline of the aimed image that can be generated later. In other words, the user can check whether or not a desired image can be generated later. Thus, convenience of imaging is improved.

In addition, the reference original image as a pan-focus image and the simple blurred image can be switched and displayed in the check display period (see FIG. 14). Therefore, the user can compare and check them. According to this comparative check, the user can easily recognize a degree of bokeh and the like of the aimed image that can be generated later.

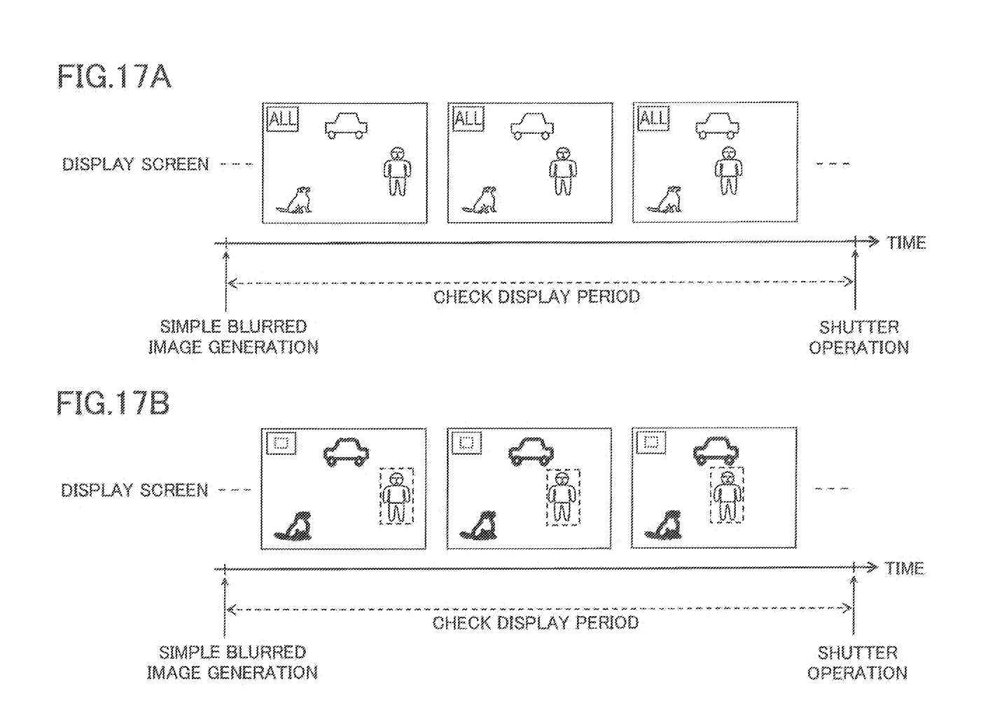

Note that the reference original image that is displayed in the check display period may be updated sequentially to be the latest one at a predetermined period. Similarly, the simple blurred image displayed in the check display period may also be updated sequentially to be one based on the latest reference original image at a predetermined period. The updating process of the reference original image and the simple blurred image displayed in the check display period is referred to as an updating process Q_{A} for a convenience sake. FIGS. 17A and 17B illustrate a manner in which the display screen is being changed when the updating process Q_{A} is performed. FIG. 17A illustrates a manner in which the reference original image obtained sequentially is updated and displayed by the updating process Q_{A}. FIG. 17B illustrates a manner in which the simple blurred image obtained sequentially is updated and displayed by the updating process Q_{A}. When the updating process Q_{A} is performed, the reference original image sequence is displayed as a moving image in a period of time while the reference original image is displayed, and the simple blurred image sequence is displayed as a moving image in a period of time while the simple blurred image is displayed, in the check display period.

In order to realize the updating process Q_{A}, it is preferable to perform a tracking process in the special imaging mode, so as to track the main subject on the reference original image sequence. If the reference original image is the first original image, the reference original image sequence means a set of first original images arranged in time series. If the reference original image is the second original image, the reference original image sequence means a set of second original images arranged in time series. Any known tracking method (for example, a method described in JP-A-2004-94680 or a method described in JP-A-2009-38777) can be used to perform the tracking process. For instance, in the tracking process, positions and sizes of the main subject on the reference original images are sequentially detected based on image data of the reference original image sequence, and the position and size of the main subject area in each reference original image are determined based on a result of the detection. The tracking process can be performed based on an image feature of the main subject. The image feature contains luminance information and color information. For individual reference original images obtained sequentially at a predetermined period, the main subject area is set and the image processing of Step S16 is performed. Then, the simple blurred image sequence corresponding to the reference original image sequence is obtained.

In addition, the process of Steps S11 to S20 illustrated in FIG. 8 may be performed when the moving image is recorded. The recorded moving image, namely, the moving image recorded in the recording medium 19 is the first original image sequence or the second original image sequence. When the process of Steps S11 to S20 is performed when the moving image is recorded, the reference original image and the first and second target original images can be a part of the moving image recorded in the recording medium 19.

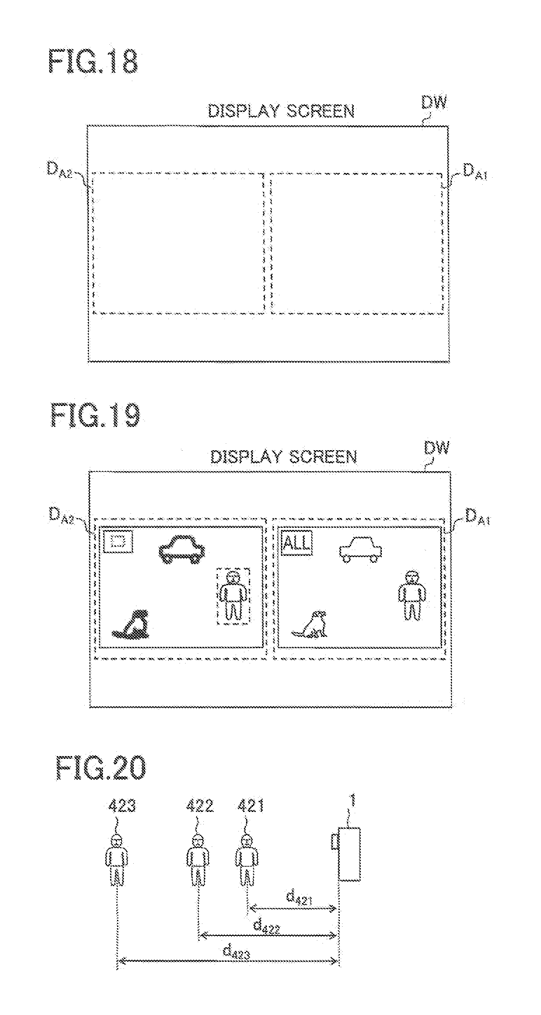

In addition, according to the action example described above, the reference original image and the simple blurred image are switched and displayed in the check display period, but it is possible to display the reference original image and the simple blurred image simultaneously in the check display period. In other words, for example, as illustrated in FIG. 18, it is possible to set display areas D_{A1} and D_{A2} that are different to each other in the entire display area DW of the display screen, and to display the reference original image in the display area D_{A1} and to display the simple blurred image in the display area D_{A2} simultaneously as illustrated in FIG. 19. In this case, it is possible to further display the icon 380 of FIG. 14 in the display area D_{A1} and to further display the icon 381 of FIG. 14 in the display area D_{A2}.

The above-mentioned updating process Q_{A} can also be applied to the action example in which the reference original image and the simple blurred image are displayed simultaneously. In this application, the reference original image in the display area D_{A1} is sequentially updated to be the latest reference original image, and the simple blurred image in the display area D_{A2} is sequentially updated to be the latest simple blurred image. The update timing of the reference original image in the display area D_{A1} and the update timing of the simple blurred image in the display area D_{A2} may be agreed with each other or may not be agreed with each other. In addition, an update period of the reference original image in the display area D_{A1} and an update period of the simple blurred image in the display area D_{A2} may be agreed with each other or may not be agreed with each other. Note that it is possible to inhibit the update of the reference original image in the display area D_{A1} and the update of the simple blurred image in the display area D_{A2} simultaneously so as to prevent an increase in load of an operational circuit or an increase in scale of the operational circuit. For instance, the update of the reference original image in the display area D_{A1} and the update of the simple blurred image in the display area D_{A2} may be performed alternately. It is also possible to perform the update of the reference original image in the display area D_{A1} a plurality of times continuously and then to perform the update of the simple blurred image in the display area D_{A2} only one time. Alternatively, it is possible to perform the update of the reference original image in the display area D_{A1} only one time and then to perform the update of the simple blurred image in the display area D_{A2} a plurality of times continuously.

In addition, the method example of recording the first and second target original images in Step S20 is described above, but it is possible to record one of the first and second target original images obtained in Step S19 and the range image in the recording medium 19 in Step S20. In this case, the process of Step S23 is performed while the process of Steps S19 and S20 is performed. In other words, the process of generating the range image from the first and second target original images obtained in Step S19 is performed before the recording process in Step S20.

In addition, it is possible to handle the main subject set just before the shutter operation is performed as the focus aimed subject, and to perform the digital focus on the process target image so that image data of the obtained aimed image is included in the record target data. More specifically, for example, it is possible to perform a first process of generating the range image from the first and second target original images after obtaining the first and second target original images in Step S19, a second process of setting the main subject set just before the shutter operation is performed as the focus aimed subject, a third process of setting the aimed depth of field, and a fourth process of generating the aimed image from the process target image and the range image by the digital focus so that the focus aimed subject is within the depth of field of the aimed image (i.e., the aimed depth of field), so as to record the aimed image obtained by the first to fourth processes in the recording medium 19 in Step S20. The first to fourth processes and the process of recording the aimed image obtained in the first to fourth processes in the recording medium 19 are collectively referred to as a recording process Q_{B}. The user can read out the aimed image recorded in the recording process Q_{B} freely from the recording medium 19 in the reproducing mode. However, also in the case where the recording process Q_{B} is performed, in Step S20, the first and second target original images are recorded in the recording medium 19, or one of the first and second target original images and the range image are recorded in the recording medium 19. It is because the aimed image recorded in the recording process Q_{B} is not always an image desired by the user.

In addition, the main control portion 20 can control whether or not the target input image or the range image is recorded in the recording medium 19 and can control a stage in which the aimed image is generated. By mode switching, their control states can be changed. In other words, the main control portion 20 can control the recording action of the recording medium 19 and the aimed image generating action of the digital focus portion 54 (generation timing of the aimed image) in a mode selected from a plurality of modes. The user can select one mode from a preset plurality of modes by a predetermined button operation or touch panel operation. The plurality of modes includes a first mode including contents of FIGS. 8 and 9 and a second mode including content of the recording process Q_{B}.

In the first mode, the main control portion 20 controls the recording medium 19 to record the first and second target original images first in Step S20. Otherwise, the main control portion 20 controls the recording medium 19 to record one of the first and second target original images and the range image. In the first mode, when the aimed image generation instruction operation is performed on the image pickup apparatus 1 later (Step S22), the process of Steps S23 to S26 or the process of Steps S24 to S26 is performed. In other words, the main control portion 20 controls the digital focus portion 54 to generate the aimed image and controls the recording medium 19 to record the aimed image that is obtained.

In the second mode, the recording process Qs is performed. In other words, in the second mode, without waiting that the aimed image generation instruction operation is performed on the image pickup apparatus 1, the main control portion 20 controls the digital focus portion 54 to generate the aimed image and controls the recording medium 19 to record the aimed image that is obtained. In this case, as described above, it is possible to control the recording medium 19 to record also the first and second target original images, or to control the recording medium 19 to record also one of the first and second target original images and the range image, but it is also possible to omit recording of the first and second target original images or recording of one of the first and second target original images and the range image. In the second mode, whether or not the first and second target original images are recorded together with the aimed image in the recording medium 19, or whether or not one of the first and second target original images and the range image are recorded together with the aimed image in the recording medium 19, may be selected and switched by a predetermined button operation or touch panel operation. The user may want to generate the aimed image at arbitrary timing after taking the image and may want only to record the aimed image without taking time. When the above-mentioned mode selection is available, the aimed image can be generated and recorded in a procedure desired by the user.

Note that the two image pickup units are disposed in the image pickup portion 11 in the example described above, but it is possible to dispose N image pickup units (N is an integer of three or larger) in the image pickup portion 11. In this case, the N image pickup units have the same structure, and there is parallax between any two of N image pickup units similarly to the case of the image pickup units 11A and 11B. Then, N original images obtained from output signals of the N image pickup units can be used to generate the range image and the aimed image. The N original images may be recorded in the recording medium 19 in the special imaging mode, and the range image may be generated from the N original images in the reproducing mode. Alternatively, the range image may be generated from the N original images in the special imaging mode, and the range image and one of the N original images may be recorded in the recording medium 19. If the number of original images having different visual points (i.e., a value of N) is larger, it is more expected that estimation accuracy of the subject distance is improved more. For instance, if an occlusion occurs in the case where the subject distance is estimated from two original images, there is a subject that appears only in one of the first and second original images. Then, it becomes difficult to estimate a subject distance of the subject. If N original images having different visual points have been obtained, the subject distance may be estimated without a problem even if such an occlusion occurs.

### Second Embodiment

A second embodiment of the present invention is described. The second embodiment is an embodiment based on the first embodiment. Description of the first embodiment can also be applied to the second embodiment unless otherwise noted in the description of the second embodiment.

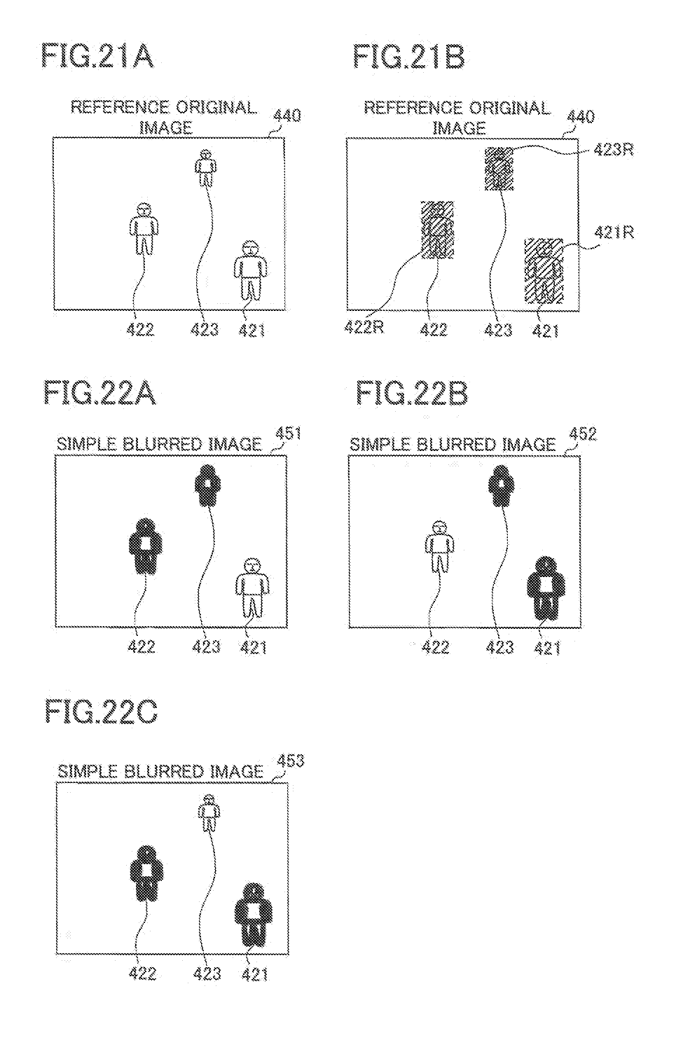

In the second embodiment, for example, it is supposed that the subject group existing within each imaging range of the image pickup units 11A and 11B includes subjects 421 to 423. Each of the subjects 421 to 423 is a person. As illustrated in FIG. 20, subject distances of the subjects 421 to 423 are referred to as d₄₂₁, d₄₂₂ and d₄₂₃, respectively. Here, it is supposed that “0<d₄₂₁, <d₄₂₂<d₄₂₃” holds. For simple description, it is supposed that the subject distances d₄₂₁, d₄₂₂ and d₄₂₃ are not changed. An image 440 of FIG. 21A is an example of the reference original image obtained by taking images of the subjects 421 to 423.

After the reference original image 440 is obtained, the main subject extracting portion 51 of FIG. 6 extracts the main subject from the subject group existing in the reference original image 440. Here, it is supposed that a plurality of main subjects are extracted. For instance, it is supposed that the face detection process is used to extract the main subject. Then, in Step S14 of FIG. 8, each of the subjects 421 to 423 is extracted as the main subject. In the next Step S15, as illustrated in FIG. 21B, there are set a main subject area 421R with respect to the person area of a person as the subject 421, a main subject area 422R with respect to the person area of a person as the subject 422, and a main subject area 423R with respect to the person area of a person as the subject 423.

In Step S16, the simple blurred image generating portion 52 sets the image area other than the main subject area 421R as the blurring target area and performs the blurring process of blurring image in the blurring target area on the reference original image 440. Thus, the simple blurred image 451 of FIG. 22A is generated. Similarly, the simple blurred image generating portion 52 sets the image area other than the main subject area 422R as the blurring target area and performs the blurring process of blurring image in the blurring target area on the reference original image 440. Thus, a simple blurred image 452 of FIG. 22B is generated. Similarly, the simple blurred image generating portion 52 sets the image area other than the main subject area 423R as the blurring target area and performs the blurring process of blurring image in the blurring target area on the reference original image 440. Thus, a simple blurred image 453 of FIG. 22C is generated. As described above in the first embodiment, it is possible to further execute a contour enhancement process on images in the main subject areas 421R to 423R when the simple blurred images 451 to 453 are generated.

In this embodiment, the period of time after the simple blurred images 451 to 453 are generated until the shutter operation is performed is the check display period. As an example of a display method in the check display period, first to third display methods are described below. The above-mentioned updating process Q_{A} can be applied to any of the first to third display methods.

[First Display Method]

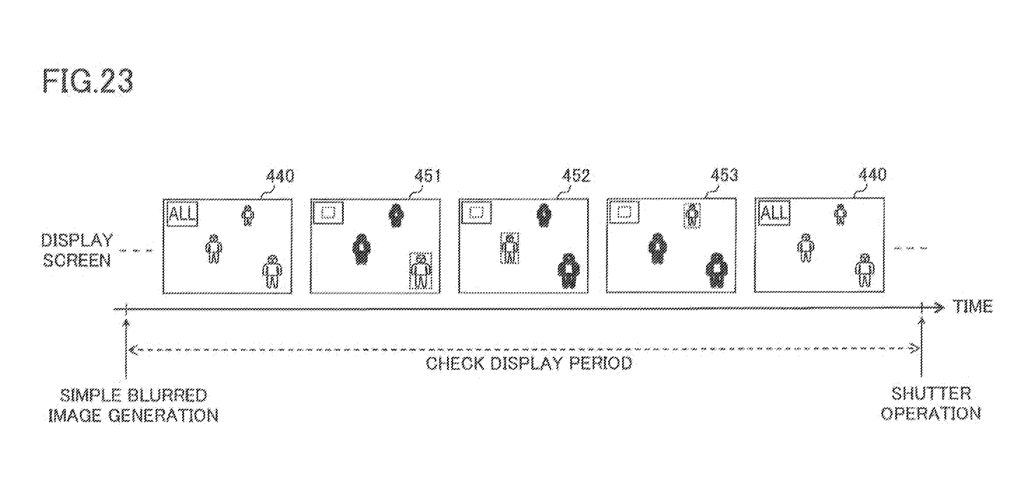

The first display method is described. In the check display period of the first display method, total four images including the reference original image 440 and the simple blurred images 451 to 453 are switched and displayed sequentially one by one. This switch and display can be performed automatically or in accordance with a user's instruction. In other words, for example, as illustrated in FIG. 23, the reference original image 440 is displayed for a certain period of time, and then the simple blurred image 451 is displayed for a certain period of time. After that, the simple blurred image 452 is displayed for a certain period of time, and still after that the simple blurred image 453 is displayed for a certain period of time. This series of display processes can be performed automatically and repeatedly in the check display period without waiting a user's instruction. Alternatively, for example, it is possible to switch the images to be displayed in the check display period among the reference original image 440, the simple blurred image 451, the simple blurred image 452 and the simple blurred image 453 in accordance with a user's instruction by a predetermined button operation or touch panel operation.

When the reference original image 440 is displayed, the icon 380 of FIG. 14 may be further displayed. When the simple blurred images 451 to 453 are displayed, the icon 381 of FIG. 14 may be further displayed (the same true in the second and third display methods described later). In addition, when the simple blurred image 451 is displayed, it is possible to display an index for notifying the user of the position and size of the main subject area 421R (e.g., a frame enclosing the periphery of the main subject area 421R) to be overlaid on the simple blurred image 451. The same is true in the case where the simple blurred images 452 and 453 are displayed, and is true in the second and third display methods described later.

The user can select any one of the simple blurred images 451 to 453 as a designated blurred image. The selection of the designated blurred image can also be performed by a predetermined button operation or touch panel operation. Alternatively, the simple blurred image displayed at the timing when the shutter operation is performed may be selected as the designated blurred image. In this case, the user can select a desired simple blurred image as the designated blurred image by performing the shutter operation in the state where a desired simple blurred image is displayed. When the designated blurred image is selected and the shutter operation is performed, it is possible to contain the main subject specifying data indicating the main subject corresponding to the designated blurred image in the above-mentioned record target data (the same is true in the second and third display methods described later). The main subjects corresponding to the simple blurred images 451 to 453 are the subjects 421 to 423, respectively.

If the record target data contains the main subject specifying data, the main subject indicated by the main subject specifying data may be set as the focus aimed subject in Step S24 of FIG. 9 (the same is true in the second and third display methods described later). The main subject specifying data defines positions of the main subject to be set as the focus aimed subject on the first and second target original images. Note that when the designated blurred image is selected and the shutter operation is performed, the above-mentioned recording process Q_{B} may be performed (the same is true in the second and third display methods described later). However, it is supposed that the main subject corresponding to the designated blurred image is set as the focus aimed subject in this recording process Q_{B}.

[Second Display Method]

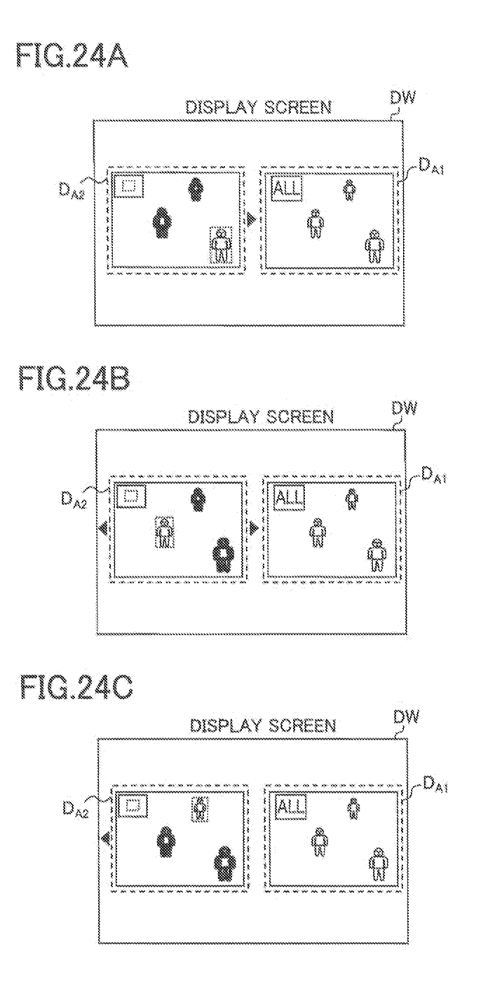

The second display method is described. In the second display method, any of the simple blurred images 451 to 453 and the reference original image 440 are displayed simultaneously in the check display period. In other words, for example, different display areas D_{A1} and D_{A2} are set in the entire display area DW of the display screen (see FIG. 18). Then, as illustrated in FIGS. 24A to 24C, the reference original image 440 is displayed in the display area D_{A1} while one of the simple blurred images 451 to 453 may be displayed simultaneously in the display area D_{A2}. In the display screen illustrated in FIGS. 24A to 24C, the simple blurred images 451 to 453 are displayed in the display area D_{A2} (numerals 451 to 453 are omitted to avoid complicated illustration).

The user can switch the image to be displayed in the display area D_{A2} by a predetermined button operation or touch panel operation. In other words, for example, when a predetermined button operation or the like is performed in the state where the simple blurred image 451 is displayed in the display area D_{A2}, the display image in the display area D_{A2} is switched from the simple blurred image 451 to the simple blurred image 452 or 453. When a predetermined button operation or the like is performed in the state where the simple blurred image 452 is displayed in the display area D_{A2}, the display image in the display area D_{A2} is switched from the simple blurred image 452 to the simple blurred image 451 or 453. As a matter of course, the switching can also be performed in the opposite direction. Note that it is possible to display an index indicating that there are a plurality of simple blurred images (corresponding to black triangle illustrated in FIGS. 24A to 24C) in the display area D_{A2} or around the display area D_{A2}.

The user can select one of the simple blurred images 451 to 453 as the designated blurred image. The selection of the designated blurred image can be performed by a predetermined button operation or touch panel operation. Alternatively, the simple blurred image displayed at the timing when the shutter operation is performed may be selected as the designated blurred image. In this case, the user can select a desired simple blurred image as the designated blurred image by performing the shutter operation in the state where the desired simple blurred image is displayed in the display area D_{A2}.

[Third Display Method]

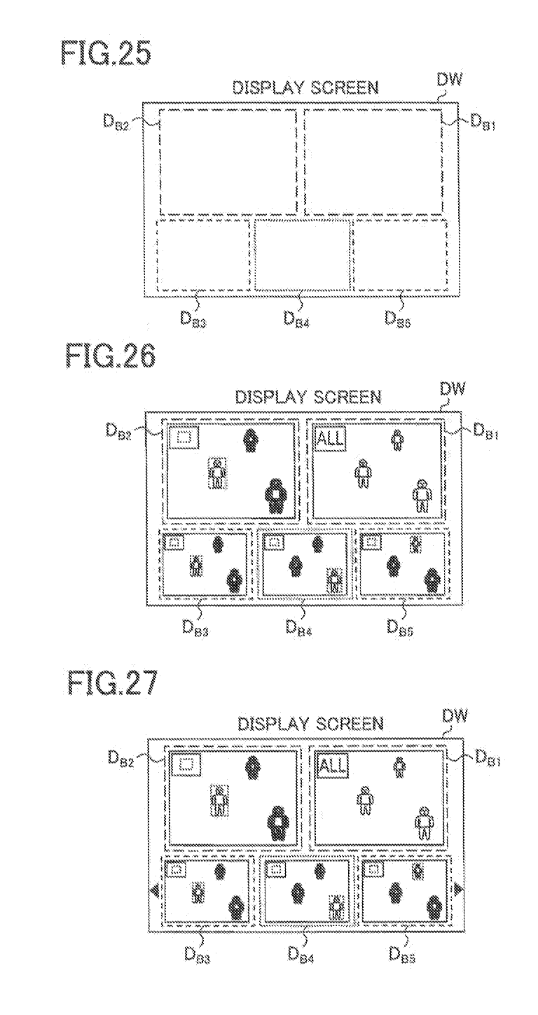

The third display method is described. In the third display method, a plurality of simple blurred images and the reference original image are displayed simultaneously in the check display period. FIG. 25 illustrates an example of setting the display screen areas used in the third display method. As illustrated in FIG. 25, it is supposed that different display areas D_{B1} to D_{B5} are set in the entire display area DW of the display screen. Here, a size of the display area D_{B2} is larger than each of the display areas D_{B3} to D_{B5}. In the example of FIG. 25, a size of the display area D_{B1} is the same as a size of the display area D_{B2}, and sizes of the display areas D_{B3} to D_{B5} are also the same.

FIG. 26 illustrates an example of display content in the third display method. Each of the display areas D_{B3} to D_{B5} displays each of the simple blurred images. The simple blurred images displayed in the display areas D_{B3} to D_{B5} are different with each other. The display area D_{B1} displays the reference original image. The display area D_{B2} displays a simple blurred image displayed in display area D_{B3}. In the example of FIG. 26, the simple blurred images 452, 451 and 453 are displayed in the display areas D_{B3} to D_{B5}, respectively, and the display areas D_{B1} and D_{B2} display the reference original image 440 and the simple blurred image 452, respectively (see also FIGS. 21A and 22A to 22C; numerals 440 and 451 to 453 are omitted in FIG. 26 for avoiding complicated illustration). Because a size of the display area D_{B2} is larger than a size of the display area D_{B3}, the display image of the display area D_{B3} is enlarged and displayed in the display area D_{B2}.

The user can switch the images displayed in the display areas D_{B2} and D_{B3} by a predetermined button operation or touch panel operation. In other words, for example, when a predetermined button operation or the like is performed in the state where the simple blurred image 451 is displayed in the display areas D_{B2} and D_{B3}, the display images in the display areas D_{B2} and D_{B3} are switched from the simple blurred image 451 to the simple blurred image 452 or 453. When a predetermined button operation or the like is performed in the state where the simple blurred image 452 is displayed in the display areas D_{B2} and D_{B3}, the display images in the display areas D_{B2} and D_{B3} are switched from the simple blurred image 452 to the simple blurred image 451 or 453. As a matter of course, the switching can be performed also in the opposite direction. Note that if another simple blurred image exists in addition to the simple blurred images 451 to 453, an index indicating that another simple blurred image exists (corresponding to black triangle illustrated in FIG. 27) may be further displayed as illustrated in FIG. 27. In this case, the user can perform a predetermined button operation or touch panel operation so that one of the display areas D_{B3} to D_{B5} displays the another simple blurred image.

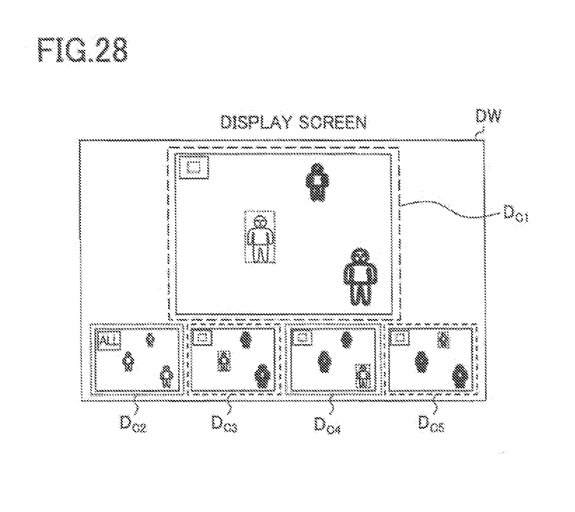

The method of splitting the display area illustrated in FIG. 25 is an example, which can be changed variously. For instance, as illustrated in FIG. 28, different display areas D_{C1} to D_{C5} are set in the entire display area DW of the display screen. Then, the reference original image may be displayed in the display area D_{C2}, while the simple blurred images may be displayed in each of the display areas D_{B3} to D_{B5}. The simple blurred images displayed in the display areas D_{C3} to D_{C5} are different with each other, and the simple blurred image displayed in the display area D_{C3} is displayed in the display area D_{C1}. A size of the display area D_{C1} is larger than each of sizes of the display areas D_{C2} to D_{C5}. In the example of FIG. 28, the simple blurred image 452, 451 and 453 are displayed in the display areas D_{C3} to D_{C5}, respectively, while the simple blurred image 452 and the reference original image 440 are displayed in the display areas D_{C1} and D_{C2} (see also FIGS. 21A and 22A to 22C; numerals 440 and 451 to 453 are omitted in FIG. 28 for avoiding complicated illustration). Because a size of the display area D_{C1} is larger than a size of the display area D_{C3}, the display image of the display area D_{C3} is enlarged and displayed in the display area D_{C1}.

The user can switch the images displayed in the display areas D_{C1} and D_{C3} by a predetermined button operation or touch panel operation. In other words, for example, when a predetermined button operation or the like is performed in the state where the simple blurred image 451 is displayed in the display areas D_{C1} and D_{C3}, the display image in the display areas D_{C1} and D_{C3} is switched from the simple blurred image 451 to the simple blurred image 452 or 453. When a predetermined button operation or the like is performed in the state where the simple blurred image 452 is displayed in the display areas D_{C1} and D_{C3}, the display image in the display areas D_{C1} and D_{C3} is switched from the simple blurred image 452 to the simple blurred image 451 or 453. As a matter of course, the switching can be performed also in the opposite direction. Note that if another simple blurred image exists in addition to the simple blurred images 451 to 453, an index indicating that another simple blurred image exists (corresponding to black triangle illustrated in FIG. 27) may be further displayed similarly to that illustrated in FIG. 27. In this case, the user can perform a predetermined button operation or touch panel operation so that the above-mentioned another simple blurred image can be displayed in one of the display areas D_{C3} to D_{C5}.

The user can select one of the simple blurred images 451 to 453 as the designated blurred image. The selection of the designated blurred image may be performed by a predetermined button operation or touch panel operation. Alternatively, the simple blurred image displayed in the display area D_{B2} or D_{C1} may be selected as the designated blurred image at the timing when the shutter operation is performed. In this case, the user can select a desired simple blurred image as the designated blurred image by performing the shutter operation in the state where the desired simple blurred image is displayed in the display area D_{B2} or D_{C1}.

### Third Embodiment

The third embodiment of the present invention is described. In the third embodiment, a modified technique of the above-mentioned technique is described, which can be applied to the first or second embodiment.

The method of generating the aimed image using the output signal of the two image pickup units 11A and 11B is described above, but it is possible to generate the aimed image by using only the output signal of the image pickup unit 11A while eliminating the image pickup unit 11B from the image pickup portion 11.

For instance, it is possible to form the image pickup unit 11A so that the first RAW data contains information indicating the subject distance, and to construct the range image and the pan-focus image from the first RAW data. In order to realize this, it is possible to use a method called “Light Field Photography” (e.g., the method described in PCT publication 06/039486 pamphlet or in JP-A-2009-224982; hereinafter referred to as a light field method). In the light field method, an imaging lens with an aperture stop and a micro lens array are used so that the image signal obtained from the image sensor contains information of the light in its propagation direction in addition to light intensity distribution on a light reception surface of the image sensor. Therefore, although not illustrated in FIG. 2B, optical members necessary for realizing the light field method is disposed in the image pickup unit 11A when the light field method is used. The optical members include a micro lens array or the like, and incident light from the subject enters the light reception surface (i.e., the imaging surface) of the image sensor 33 via the micro lens array and the like. The micro lens array includes a plurality of micro lenses, in which one micro lens is assigned to one or more light reception pixels on the image sensor 33. Thus, the output signal of the image sensor 33 contains information of the incident light to the image sensor 33 in its propagation direction in addition to light intensity distribution on the light reception surface of the image sensor 33. Using this information, the range image can be generated, and the pan-focus image can be constructed from the first RAW data containing this information.

It is possible to generate an ideal or pseudo-pan-focus image from the first RAW data using a method that is not classified as the light field method (e.g., a method described in JP-A-2007-181193). For instance, it is possible to use a method of generating the pan-focus image using a phase plate (a wavefront coding optical element), or to use an image restoring process in which bokeh of an image on the image sensor 33 is removed so that the pan-focus image is generated.

The pan-focus image obtained as described above based on the first RAW data can be used as the first original image, and the first original image based on the first RAW data can be used as the reference original image, the first target original image and the process target image (see Steps S13, S19, S25 and the like in FIG. 8 or 9). In this case, it can be considered that the target input image to be obtained by instruction of the shutter operation is a pan-focus image based on the first RAW data. Note that the image having any in-focus distance and any depth of field can be constituted freely after the image signal is obtained from the image sensor 33 in the light field method. Therefore, when the light field method is used, it is possible to generate the aimed image directly from the first RAW data without constituting the pan-focus image.

In addition, it is possible to use a method that is not classified as the light field method so as to generate a range image of an arbitrary original image. For instance, like the method described in JP-A-2010-81002, axial color aberration of the optical system 35 may be used so that the range image of an arbitrary original image is generated based on the output signal of the image sensor 33. Alternatively, for example, a range sensor (not shown) for measuring a subject distance of each subject in the imaging range of the image pickup unit 11A or 11B may be disposed in the image pickup apparatus 1, and the range image of an arbitrary original image may be generated based on a result of the measurement by the range sensor.

### VARIATIONS

The embodiments of the present invention can be modified variously as necessary within the technical concept described in the claims. The embodiments described above are merely examples of embodiments of the present invention. Meanings of the present invention and terms of elements are not limited to those described in the embodiments described above. Specific values exemplified in the description are merely examples, which can be changed variously as a matter of course.

The image pickup apparatus 1 of FIG. 1 can be constituted of hardware or a combination of hardware and software. When the image pickup apparatus 1 is constituted of software, a block diagram of a portion realized by software expresses a functional block diagram of the portion. A function realized by software may be described as a program, and the program may be executed by a program execution device (e.g., a computer) so that the function is realized.

In each embodiment described above, the digital focus portion 54 works as the aimed image generating portion that generates the aimed image. The range image in each embodiment described above is a type of distance information (range information) for specifying the subject distance of the subject in each pixel position of a noted original image. As long as the subject distance of the subject in each pixel position of the noted original image can be specified, the distance information may not be image form information such as range image, but may be any form information.

What is claimed is:

1. An image pickup apparatus comprising:
an image pickup portion that outputs an image signal of a subject group including a specific subject and a non-specific subject;
an operating portion that receives an operation to instruct to obtain a target input image based on an output signal of the image pickup portion;
a recording medium that records the target input image;
an aimed image generating portion that generates an aimed image in which the specific subject is focused by performing a first image processing on the target input image when a predetermined operation is performed on the operating portion after the target input image is recorded;
a display portion; and
a blurred image generating portion that generates a blurred image in which the non-specific subject is blurred by performing a second image processing different from the first image processing on the output signal of the image pickup portion before the operation to instruct to obtain is performed, wherein
the blurred image is displayed on the display portion before the target input image is obtained in accordance with the operation to instruct to obtain.

2. The image pickup apparatus according to claim 1, wherein the target input image includes a plurality of target original images, and a depth of field of each target original image is deeper than a depth of field of the aimed image.

3. The image pickup apparatus according to claim 2, wherein
the plurality of target original image have different visual points, and
the aimed image generating portion generates the aimed image using distance information of the subject group based on the plurality of target original images.

4. The image pickup apparatus according to claim 1, wherein the aimed image generating portion generates the aimed image using distance information of the subject group.

5. The image pickup apparatus according to claim 1, wherein before the target input image is obtained in accordance with the operation to instruct to obtain, the blurred image and an image to be a basis of the blurred image are switched and displayed on the display portion, or are displayed simultaneously on the display portion.

6. The image pickup apparatus according to claim 1, further comprising a subject extracting portion that extracts a subject to be the specific subject among the subject group based on the output signal of the image pickup portion, wherein
when the subject extracting portion extracts a plurality of subjects, the blurred image generating portion generates a plurality of blurred images by performing image processing as the second image processing on the output signal of the image pickup portion before the operation to instruct to obtain is performed, the image processing being performed so that, for each one of the extracted subjects, any subject other than that one extracted subject is blurred, and wherein
the plurality of blurred images are switched and displayed on the display portion or displayed simultaneously on the display portion before the target input image is obtained in accordance with the operation to instruct to obtain.

7. The image pickup apparatus according to claim 1, further comprising a control portion that controls a recording action of the recording medium and an aimed image generating action of the aimed image generating portion in a mode selected from a plurality of modes, wherein the plurality of modes includes
a first mode in which the target input image is recorded in the recording medium, and later the aimed image generating portion generates the aimed image from the target input image when the predetermined operation is performed on the operating portion, and
a second mode in which the aimed image generating portion generates the aimed image from the target input image and records the aimed image in the recording medium without waiting a predetermined operation performed on the operating portion.

8. An image pickup apparatus comprising:
an image pickup portion that outputs an image signal of a subject group including a specific subject;
an operating portion that receives an operation to instruct to obtain a target input image based on an output signal of the image pickup portion;
a recording medium;
an aimed image generating portion that generates an aimed image in which the specific subject is focused by performing an image processing on the target input image; and
a control portion that controls a recording action of the recording medium and an aimed image generating action of the aimed image generating portion in a mode selected from a plurality of modes, wherein the plurality of modes includes
a first mode in which the target input image is recorded in the recording medium, and later the aimed image generating portion generates the aimed image from the target input image when a predetermined operation is performed on the operating portion, and
a second mode in which the aimed image generating portion generates the aimed image from the target input image and records the aimed image in the recording medium without waiting the predetermined operation performed on the operating portion.
